(19) United States
(12) Patent Application Publication
(10) Pub. No.: US 2007/0064880 A1
(43) Pub. Date: Mar. 22, 2007

(54) Method for configuring power loops between a central office and a service access interface

(75) Inventors: Arvind R. Mallya, Walnut Creek, CA (US); Mahmoud Elkenaney, Austin, TX (US); Don Murray, Sparks, NV (US); Kevin J. Moisan, Castro Valley, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/229,563

(22) Filed: Sep. 19, 2005

(51) Int. Cl. H04M 1/24

(52) U.S. Cl. 379/29.01

(57) ABSTRACT

A system and method are disclosed for configuring power loops between a central office (CO) 106 and a service access interface (SAI) 110. A system that incorporates teachings of the present disclosure may include, for example, a network management system (NMS) 100 having a memory 104, and a controller 102. The controller is programmed to retrieve (206) topology information relating to a selected power loop originating at a CO and terminating at an SAI, identify (207) environment conditions to be applied to the selected power loop, and determine (208, 218) from the topology information and the environment conditions whether the power loop can carry sufficient energy without exceeding a temperature rating.

### FIELD OF THE DISCLOSURE

The present disclosure relates generally to power loops in telecommunication networks, and more specifically to a method for configuring power loops between a central office (CO) and a service access interface (SAI).

### BACKGROUND

As broadband services such as high definition TV (HDTV), voice over IP (VoIP), and high speed data links expand to residences, telecommunication service providers are expected to incorporate new communication technologies in the SAIs. In a POTS environment, SAIs will generally not have appropriate power sourcing from the CO to support these additional technologies.

A need therefore arises for a method to configure power loops between the CO and the SAI.

### BRIEF DESCRIPTION OF THE DRAWINGS

FIG. 1 is a block diagram of power and communication cabling between a central office (CO) and a service access interface (SAI) according to teachings of the present disclosure;

FIG. 2 depicts a flowchart of a method operating in a network management system associated with the CO according to teachings of the present disclosure; and

FIG. 3 is a diagrammatic representation of a machine in the form of a computer system within which a set of instructions, when executed, may cause the machine to perform any one or more of the methodologies discussed herein.

### DETAILED DESCRIPTION

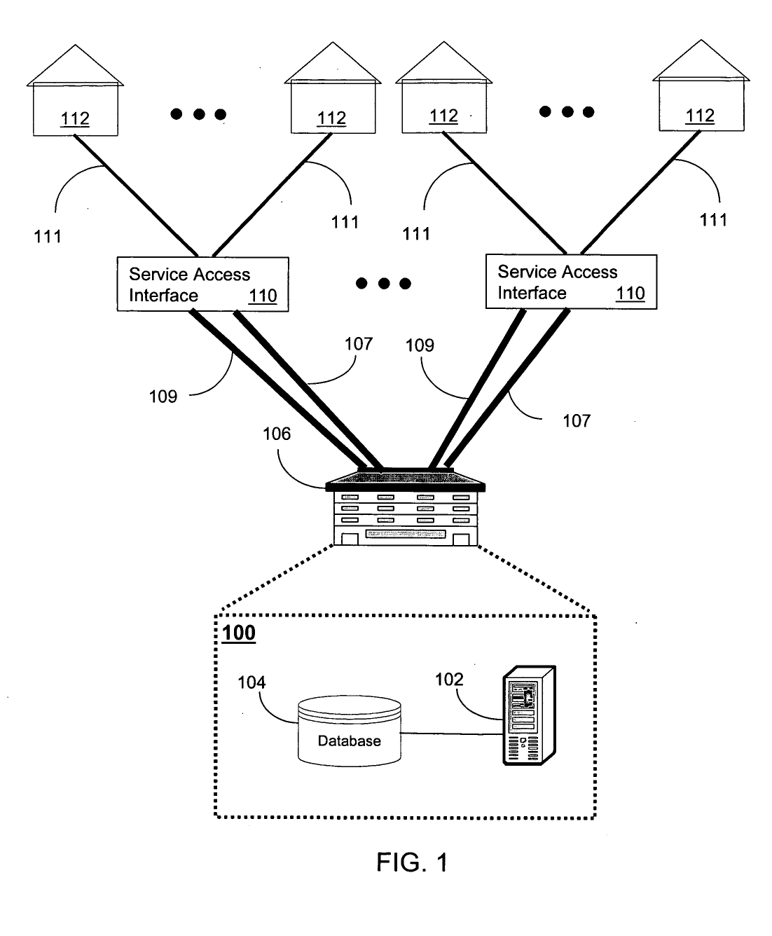

FIG. 1 is a block diagram of power and communication cabling between a central office (CO) 106 and a service access interface (SAI) 110 according to teachings of the present disclosure. The CO 106 can distribute telecommunication services by way of the SAI 110 to buildings 112 such as residences or commercial enterprises. For illustration purposes only, buildings 112 will herein be referred to as residences 112. Telecommunication services of the CO 106 can include traditional POTS (Plain Old Telephone Service) and broadband services such as VoIP (Voice over Internet communications, IPTV (Internet Protocol Television), Internet services, and so on. To support broadband services, the SAI 106 can include active circuits such as an optical interface for translating optical signals originating from the CO 106 on fiber links 109 to electrical signals distributed on, for example, twisted copper pairs 111 to residences 112. Links 107 can be twisted copper pairs for distributing power to the SAIs 110 throughout a region such as a city or metropolitan area.

The CO 106 can include a network management system (NMS) 100 that among other functions can manage power distribution to the SAIs 110. The NMS 100 can comprise a controller 102 and a memory 104. The controller 102 utilizes common computing technology such as a desktop computer or scalable server. The memory 104 can be a mass storage medium such as a high-density disk drive for managing, for example, a database that maintains topologies of all interconnects between the CO 106 and the SAIs 110, and the SAIs 110 and residences 112. It would be apparent to an artisan with ordinary skill in the art that one or more NMS 100 can be used to perform power management services for more than one CO 106. Thus FIG. 1 provides a single instance of an embodiment of the NMS 100, which should not be construed as limiting the scope of the present disclosure.

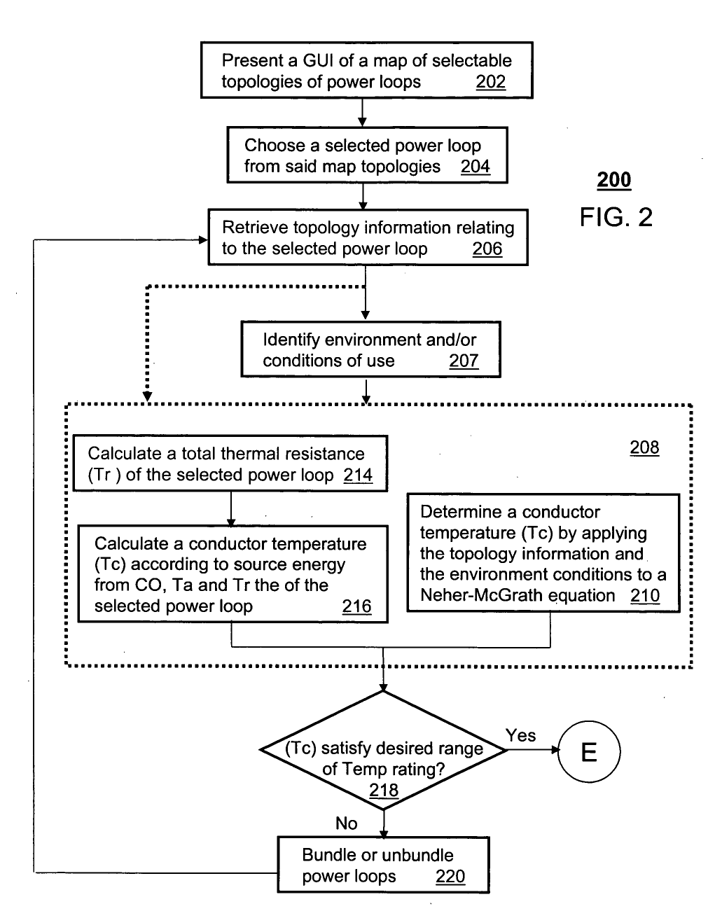

FIG. 2 depicts a flowchart of a method 200 operating in the NMS 100 associated with the CO 106 according to teachings of the present disclosure. Method 200 begins with step 202 whereby service personnel of the CO 106 can be presented with a GUI (Graphical User Interface) of a map selectable topologies of power loops between the CO 106 and the SAI 110. In step 204, the service personnel can select a power loop from said map of topologies to analyze. In step 206, the NMS 100 retrieves topology information relating to the selected power loop.

Topology information can include, but is not limited to, the length of the power loop, its physical characteristics (e.g., gauge, insulation material used, insulation thickness, outer conductor diameter, outer jacket diameter, surface area of the cable, diameter of the cable, etc.), number of twisted pairs in the power loop, the medium in which the power loop is distributed to the SAI 110 (e.g., aerial versus buried transport, depth of buried cable with or without a duct, outer diameter of duct, etc.), and thermal and resistive characteristics (e.g., conductor temperature rise due to dielectric losses, total conductor resistance, loss increment due to conductor skin and proximity effects, thermal resistance between the conductor and ambient temperature, type of soil and its thermal resistivity), just to mention a few. In step 207, the service personnel can identify environment and/or desired conditions of use such as a desired source current (or ampacity) to support anticipated load requirements of active circuits operating in the SAI 110, ambient temperature, and so on.

From the topology information and environment conditions, the NMS 100 proceeds to step 208 where it determines whether the selected power loop can carry sufficient energy without exceeding a desired operating condition. An operating conditions in the present context can be derived from standards such as the National Electrical Code (NEC) in the form of a temperature rating of the power loop. Alternatively, operating conditions can be defined by the service provider in the form of an acceptable power loss, voltage drop, or other operating means for proper functioning of active circuits at the SAI 110.

FIG. 2 illustrates two embodiments of step 208. In a first embodiment, the NMS 100 can be programmed to use a Neher-McGrath equation given by:

$$I = \sqrt{\frac{Tc - ( Ta + Delta TD )}{Rdc ( 1 + Yc ) Rca}}$$

where I represent the ampacity of the cable in kilo amperes, Tc represents the conductor temperature in degrees Celsius, Ta represents the operating ambient temperature in degrees Celsius, Delta TD represents the conductor temperature rise due to a dielectric loss in degrees Celsius, Rdc represents the total conductor DC resistance in microhms per foot, Yc represents the loss increment due to conductor skin and proximity effects, and Rca represents the thermal resistance between the conductor and ambient temperature in thermal-ohm-feet. The Neher-McGrath equation has been widely used by utility companies for power grid analysis, but never in a telecommunications setting as in the present disclosure. Thus in step 210, the NMS 100 can be programmed to apply the topology information retrieved in step 206 and desired operating conditions provided in step 207 to solve for the conductor temperature (Tc).

In a second embodiment, the NMS 100 can be programmed to utilize a modified version of the Neher-McGrath equation as given by:

$$I = \sqrt{\frac{Tc - Ta}{Rdc}}$$

In DC (Direct Current) power distributions, the Delta TD, Yc and Rca terms have minimal contribution. Thus, the conductor temperature (Tc) can be solved by approximation with the above simpler equation. Thus, the NMS 100 operations can be reduced to steps 214 and 216. In step 214 a total thermal resistance can be calculated (Rdc) according to any one or more thermal resistances included in the topology information retrieved in step 206 such as, for example, an insulation resistance (Ri), a polyethelene resistance (Rpe), a polyvinylchloride resistance (Rpvc), a duct to Earth resistance (Re), a cable to solar aerial resistance (Rsa), and/or a cable to soil resistance (Rs). Once Rdc has been solved, the NMS 100 in step 216 solves for Tc according to a desired ampacity (I) and operating ambient temperature Ta given in step 207.

If in step 218 Tc is within a desired range of the temperature rating of the conductor as defined by NEC, then the analysis ends indicating the selected power loop can support the desired power loading requirements of the corresponding SAI 110. If, on the other hand, Tc is outside the desired range (e.g., it exceeds the temperature rating or is excessively below the temperature rating), then the NMS 100 can be programmed to proceed to step 220 where it either bundles other available power loops with the selected power loop to lower Tc, or unbundles the selected power loop from one or more other power loops to make available power loops for other SAIs 110.

In either case, the NMS 100 proceeds to steps 206 where it retrieves topology information from new loops added and repeats the aforementioned embodiments for calculating Tc in step 208. Step 207 can be skipped if the desired operating conditions remain the same. The Tc calculated in step 208 is again compared to the temperature rating of the power loop in step 218. If the bundling or unbundling effect brings Tc within a desired range of the temperature rating, then the NMS 100 ends the analysis. Otherwise the NMS 100 continues to make further attempts to find a proper configuration for the selected power loop.

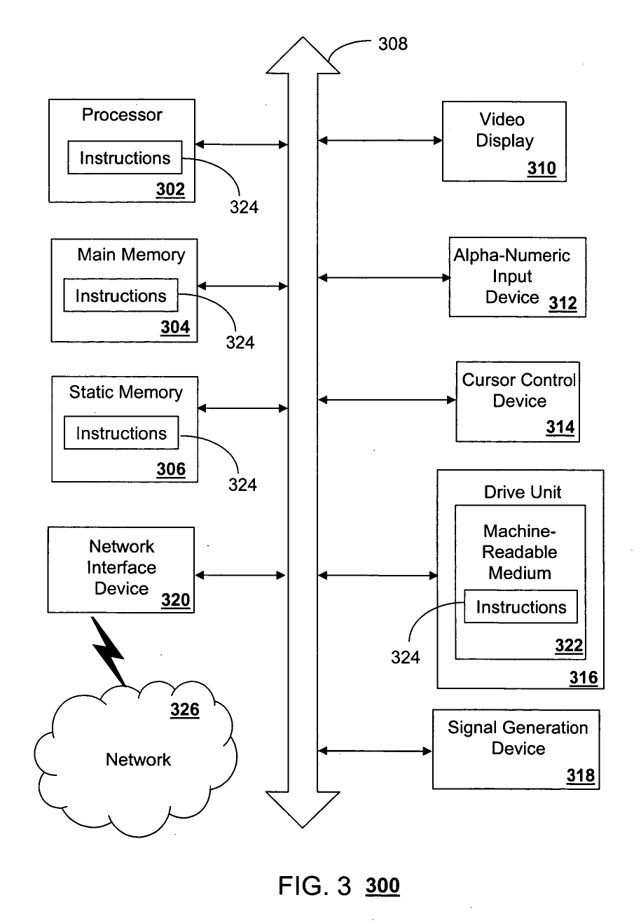

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising the steps of:
searching for topology information relating to a selected power loop originating at a central office (CO) and terminating at a service access interface (SAI); and
determining whether the selected power loop can carry sufficient energy under conditions of use without exceeding a temperature rating.

2. The method of claim 1, comprising the steps of:
reconfiguring the selected power loop when it exceeds the temperature rating; and
determining whether the updated power loop can carry sufficient energy without exceeding the temperature rating.

3. The method of claim 2, comprising the step of repeating the foregoing steps until a power loop configuration is found that satisfies within a desired range the temperature rating under use conditions.

4. The method of claim 1, comprising the steps of:
bundling the selected power loop with one or more other power loops of the CO when it exceeds the temperature rating; and
determining whether the bundled power loop can carry sufficient energy without exceeding the temperature rating.

5. The method of claim 1, comprising the steps of:
unbundling the selected power loop from one or more other power loops of the CO when it falls below the temperature rating; and
determining whether the unbundled power loop can carry sufficient energy without exceeding the temperature rating.

6. The method of claim 1, comprising the steps of:
selecting a desired source of energy from the CO for application on the selected power loop;
selecting an ambient temperature for the selected power loop;
calculating a total thermal resistance of the selected power loop;
calculating a conductor temperature of the selected power loop according to the desired source of energy, the ambient temperature, and the thermal resistance; and
comparing the conductor temperature to the temperature rating.

7. The method of claim 6, comprising the step of calculating from the topology information the total thermal resistance of the selected power loop according to at least one among a group of thermal resistances comprising an insulation resistance (Ri), a polyethelene resistance (Rpe), a polyvinylchloride resistance (Rpvc), a duct to Earth resistance (Re), a cable to solar aerial resistance (Rsa), and a cable to soil resistance (Rs).

8. The method of claim 1, comprising the steps of:
calculating a conductor temperature of the selected power loop by applying the topology information and conditions of use to a Neher-McGrath equation; and
comparing the conductor temperature to the temperature rating.

9. The method of claim 1, comprising the steps of:
presenting a GUI (Graphical User Interface) of a map of selectable topologies of one or more power loops between the CO and the SAI; and
choosing the selected power loop from said map for performing the foregoing steps.

10. A network management system (NMS), comprising:
a memory; and
a controller programmed to:
retrieve topology information relating to a selected power loop originating at a CO and terminating at an SAI;
identify environment conditions to be applied to the selected power loop; and
determine from the topology information and the environment conditions whether the selected power loop can carry sufficient energy without exceeding a temperature rating.

11. The NMS of claim 10, wherein the controller is programmed to:
reconfigure the selected power loop when it exceeds the temperature rating;
determine from the environment conditions whether the updated power loop topology can carry sufficient energy without exceeding the temperature rating; and
repeat the foregoing steps until a power loop configuration is found that satisfies a desired range of the temperature rating.

12. The NMS of claim 10, wherein the controller is programmed to:
bundle the selected power loop with one or more other power loops of the CO when it exceeds the temperature rating;
determine whether the bundled power loop can carry sufficient energy without exceeding the temperature rating;
unbundle the selected power loop from one or more other power loops of the CO when it falls below the temperature rating;
determine whether the unbundled power loop can carry sufficient energy without exceeding the temperature rating; and
repeat a portion of the foregoing steps until a desired power loop bundle is found.

13. The NMS of claim 10, wherein the controller is programmed to:
select a desired source current to apply to the selected power loop;
select an ambient temperature for the selected power loop;
calculate a total thermal resistance of the selected power loop;
calculate a conductor temperature in the selected power loop according to the desired source current, the ambient temperature, and the thermal resistance; and
compare the conductor temperature to the temperature rating.

14. The NMS of claim 13, wherein the controller is programmed to calculate from the topology information the total thermal resistance of the selected power loop according to at least one among a group of thermal resistances comprising an insulation resistance (Ri), a polyethelene resistance (Rpe), a polyvinylchloride resistance (Rpvc), a duct to Earth resistance (Re), a cable to solar aerial resistance (Rsa), and a cable to soil resistance (Rs).

15. The NMS of claim 10, wherein the controller is programmed to:
calculate a conductor temperature of the selected power loop by applying the topology information and environment conditions to a Neher-McGrath equation; and
compare the conductor temperature to the temperature rating.

16. The NMS of claim 10, wherein the controller is programmed to:
calculate a conductor temperature of the power loop from the topology information and environment conditions; and
compare the conductor temperature to the temperature rating.

17. The NMS of claim 10, wherein the controller is programmed to:
present a GUI (Graphical User Interface) of a map of selectable topologies of one or more power loops between the CO and the SAI; and
choose the selected power loop from said map.

18. A computer-readable storage medium, comprising computer instructions for:
searching for topology information relating to a selected power loop originating at a CO and terminating at an SAI; and
determining from the topology information and conditions of use whether the selected power loop can carry sufficient energy without exceeding a desired operating condition.

19. The storage medium of claim 18, comprising computer instructions for:
selecting a source of energy to apply to the selected power loop;
selecting environment conditions for operating the selected power loop;
determining a conductor resistance of the selected power loop;
calculating an operating condition according to the source of energy, environment conditions, and conductor resistance; and
comparing the operating condition to the desired operating condition.

20. The storage medium of claim 18, wherein the desired operating condition comprises a temperature rating, and wherein the storage medium comprises computer instructions for:
calculating a conductor temperature of the selected power loop according to the topology information and the conditions of use;
reconfiguring the power loop when conductor temperature is outside a desired range of the temperature rating; and
repeating the foregoing steps until a power loop configuration is found that satisfies the desired range of the temperature rating.
